(19) United States
(12) Patent Application Publication
(10) Pub. No.: US 2017/0205795 A1
(43) Pub. Date: Jul. 20, 2017

(54) METHOD FOR PROCESS OPERATORS TO PERSONALIZE SETTINGS FOR ENABLING DETECTION OF ABNORMAL PROCESS BEHAVIORS

(71) Applicant: Yokogawa Electric Corporation, Tokyo (JP)

(72) Inventors: Vijaya Rama Raju PENUMATCHA, Plano, TX (US); Patrick CLAY, Frisco, TX (US); Andrew KELLER, Lewisville, TX (US)

(73) Assignee: Yokogawa Electric Corporation, Tokyo (JP)

(21) Appl. No.: 14/996,551

(22) Filed: Jan. 15, 2016

(51) Int. Cl. G05B 19/042

(52) U.S. Cl. CPC G05B 19/0428; G05B 2219/25428; G05B 2219/24011

(57) ABSTRACT

A system, method, and an apparatus relating to automatically setting up pre-upset warning conditions for entire systems based on drifting parameters. The drifting parameters may provide monitoring to operate the process so that the upset condition is never reached, by allowing the operator can take actions so that the process remains in a stable state. The aim is to monitor and limit variations in parameters to enable the operator to achieve a much tighter control on the process and not allow the alarm to occur in the first place. Additionally, the important values may be displayed in context, and the operator may directly manipulate the values through a variety of touch input.

### FIELD OF THE INVENTION

Exemplary embodiments relate to field device communications systems and methods, user interfaces, and the monitoring of industrial automation processes.

### BACKGROUND

In the related art within industrial plant environments, particularly those utilizing Industrial Automation (IA), there are control systems for the monitoring and adjustment of field devices. Examples of such a control system include a distributed control system (DCS), such as the [CENTUM VP]®. The field devices are used for measuring physical properties, quantities, or characteristics, such as flow rate, temperature, level, or pressure. In the related art, the operator generally uses a console in a control room to control the IA process. Additionally, field devices can be used to modify these physical properties for the purpose of controlling the process or providing safeguards the IA process.

In some cases of providing safeguards to the IA process, the field devices can be configured to notify a user or system of excessive measured physical values, and triggering an alarm based on the conditions or notifying device diagnostics. The ISA 18.2 2009 standard describes one type of an alarm management standard. As part of the standard, one element describes a concept of pre-upset warnings. These warnings are capable of notifying the operator when some part of the process moves away from an ideal value and can provide the operator ample time to prevent the process from triggering an alarm.

FIG. 1 shows a related art example of a user interface screen (100) showing that an alarm (101) for a field device has been triggered.

Additionally, the operator's interaction with the user interface of the control system for the alarm has traditionally been achieved through a text entry method. FIGS. 13, 14, 15, and 16 show related art examples of user interface screens for monitoring of the IA process as well as entry of an ideal value.

FIG. 13 shows a related art faceplate display (1301) for a field device (1302). In an exemplary application, the faceplate display (1301) indicates an operation mode (1303), a setpoint variable (SV) (1305), a manipulated variable (MV) (1306), a process variable (PV) (1304), and a graphical display (1307). The PV (1304) is indicated by the bar graph of the graphical display (1307), and the SV (1305) and the MV (1306) are indicated by triangle indicators to the side of the bar graph on the graphical display (1307).

FIG. 15 shows a related art user interface tuning panel showing the faceplate display (1501) as well as other displays of data measurements (1502) and an information graph (1503).

When the operator desires to change a variable, such as the SV (1305) or MV (1306), the operator can double click on the associated area on the faceplate (1301, 1501) to bring up a menu as shown in FIGS. 14 and 16. The menu would show the current setting (1401, 1601) and an entry field for the desired setting (1402, 1602). To alter a setting parameter, the operator can then enter the desired setting into the entry field (1402, 1602) through a keyboard.

### SUMMARY

One or more embodiments relate to a method for setting drift warnings for monitoring processes. The method includes configuring a desired range for an acceptable drift range of a process, setting a desired parameter value for the operating of the process, detecting an actual parameter value of the process, comparing the actual parameter value to the desired parameter value and the desired range, and displaying an indication of a drift occurrence when the actual parameter value is within the desired range but different from the desired parameter value.

In some embodiments, the method includes automatically adjusting a field device parameter to maintain the actual parameter value at the desired parameter value.

According to one or more embodiments, the method includes that at least one of an adjustment of the desired parameter value and drift range is by a touch input of an operator.

In exemplary embodiments, the adjustment occurs through at least two touch inputs, where a first touch input is configured to make the adjustment at a first rate corresponding to the movement of the touch input of the operator, and where a second touch input is configured to make the adjustment at a second rate, proportionally different from the first rate, corresponding to the movement of the touch input of the operator.

Embodiments of the method may further comprise recording a current desired parameter value of a process.

Embodiments of the method may further comprise saving the desired parameter value and the desired range into a configuration file.

Embodiments of the method may provide for recording a desired parameter value of the process, wherein the process is selectable from a hierarchy of levels of processes such that the recording is configured to record the desired parameter value of the process and desired parameter values of associated lower level processes.

One or more embodiments relate to a system comprising at least one device for setting drift warnings for monitoring processes. The system includes at least one non-transitory computer readable medium operable to store program code and at least one processor operable to read said program code and operate as instructed by the program code. The program code includes configuring a desired range for an acceptable drift range of a process, setting a desired parameter value for the operating of the process, detecting an actual parameter value of the process, comparing the actual parameter value to the desired parameter value and the desired range, and displaying an indication of a drift occurrence when the actual parameter value is within the desired range but different from the desired parameter value.

According to one or more embodiments, the program code further includes automatically adjusting a field device parameter to maintain the actual parameter value at the desired parameter value.

In exemplary embodiments, at least one of an adjustment of the desired parameter value and drift range is by a touch input of an operator.

In some embodiments, the adjustment occurs through at least two touch inputs, where a first touch input is configured to make the adjustment at a first rate corresponding to the movement of the touch input of the operator, and where a second touch input is configured to make the adjustment at a second rate, proportionally different from the first rate, corresponding to the movement of the touch input of the operator.

Embodiments of the system include that the program code includes recording a current desired parameter value of a process.

Embodiments of the system include that the program code includes saving the desired parameter value and the desired range into a configuration file.

In one or more embodiments, the program code include receiving a device identifier associated with a process management console, retrieving configuration data for connection to the process management console, and automatically configuring the system to connect to the process management console based on the configuration data, where the process management console provides information regarding the process to the system.

One or more embodiments relate to an apparatus for setting drift warnings for monitoring processes. The apparatus includes at least one non-transitory computer readable medium operable to store program code and at least one processor operable to read said program code and operate as instructed by the program code. The program code includes configuring a desired range for an acceptable drift range of a process, setting a desired parameter value for the operating of the process, detecting an actual parameter value of the process, comparing the actual parameter value to the desired parameter value and the desired range, and displaying an indication of a drift occurrence when the actual parameter value is within the desired range but different from the desired parameter value.

According to one or more embodiments, the program code further comprises automatically adjusting a field device parameter to maintain the actual parameter value at the desired parameter value.

In exemplary embodiments, at least one of an adjustment of the desired parameter value and drift range is by a touch input of an operator.

In some embodiments, the adjustment occurs through at least two touch inputs, where a first touch input is configured to make the adjustment at a first rate corresponding to the movement of the touch input of the operator, and where a second touch input is configured to make the adjustment at a second rate, proportionally different from the first rate, corresponding to the movement of the touch input of the operator.

Embodiments of the system include that the program code includes recording a current desired parameter value of a process.

Embodiments of the system include that the program code includes saving the desired parameter value and the desired range into a configuration file.

In one or more embodiments, the program code include receiving a device identifier associated with a process management console, retrieving configuration data for connection to the process management console, and automatically configuring the system to connect to the process management console based on the configuration data, where the process management console provides information regarding the process to the system.

### BRIEF DESCRIPTION OF THE DRAWINGS

FIG. 1 illustrates a related art example of a user interface for displaying an alarm condition for an IA process.

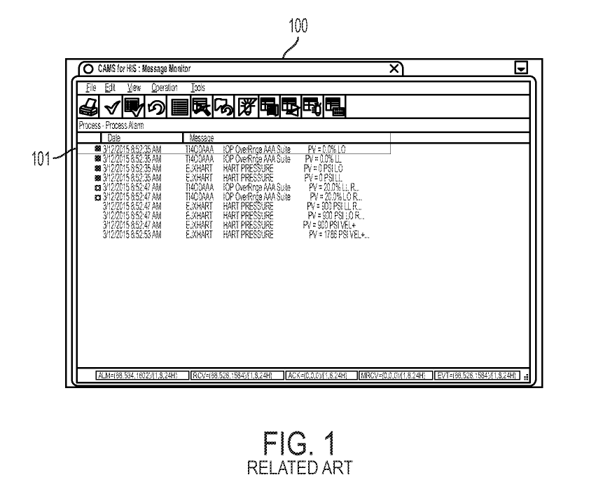

FIG. 2 illustrates an exemplary embodiment of a user interface for displaying configurations of IA processes.

FIG. 3 illustrates an exemplary embodiment of a user interface for displaying indication of drift of IA processes.

FIG. 4 illustrates an exemplary embodiment of a user interface for displaying drift setting configurations of IA processes.

FIG. 5 illustrates an exemplary embodiment of a user interface for displaying configurations of IA processes and a snapshot.

FIG. 6 illustrates an exemplary embodiment of a user interface for a snapshot interface for configurations of IA processes.

FIG. 7 illustrates an exemplary embodiment of a user interface for a snapshot interface for configurations of IA processes.

FIG. 8 illustrates a graph for evaluation of an operator's efficiency.

FIG. 9 illustrates a flowchart of a related art method of validating a mobile device with a console.

FIG. 10 illustrates a configuration data chart of information for validation of a mobile device with a console.

FIG. 11 illustrates a flowchart of an exemplary embodiment of validating a mobile device with a console.

FIG. 12 illustrates a flowchart of an exemplary embodiment of validating a mobile device with a console through [BLUETOOTH]®.

FIG. 13 illustrates a related art faceplate display.

FIG. 14 illustrates a related art menu to alter a setting parameter.

FIG. 15 illustrates a related art user interface including the faceplate display.

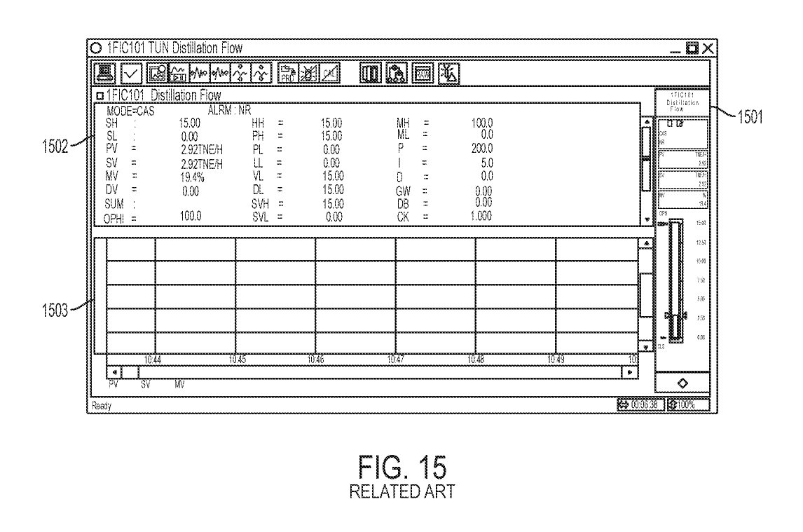

FIG. 16 illustrates a related art menu to alter a setting parameter.

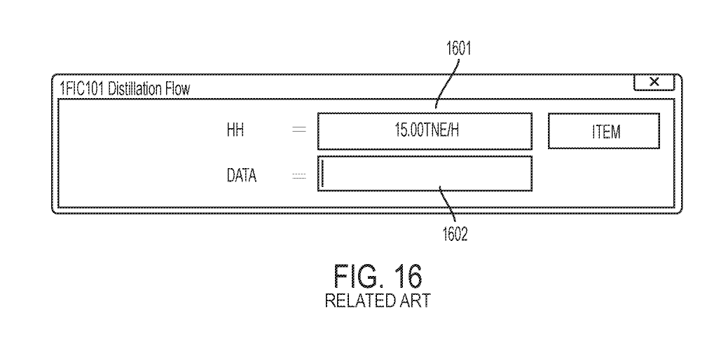

FIG. 17 illustrates an exemplary embodiment of a user interface for touch adjustment of a setting parameter.

FIG. 18 illustrates an exemplary embodiment of a user interface configured for two fingers touch interaction.

FIG. 19 illustrates an exemplary embodiment of a user interface configured for one finger touch interaction.

FIG. 20 illustrates an exemplary embodiment of a user interface configured for boundary limitations of touch by an operator.

FIG. 21 illustrates an exemplary embodiment of a user interface configured for changing of visible range of a displayed graph by an operator.

FIG. 22 illustrates an exemplary embodiment of a device configured to show the user interface.

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein, and equivalent modifications. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

In the related art usage of alarms, when an alarm occurs this indicates that the process is already in an upset condition.

During states of stable operation of the plant processes, operators monitor the operating states of the plant processes and the associated field devices through a monitoring system. As part of this monitoring, the operators are waiting for alarms to occur. In normal process operations when the process is stable, the operators do not have much activity and are waiting for a process upset of the operating state. When this happens, especially during night shifts when no outside activities occur, the operators are prone to boredom and their ability to respond to/have awareness of, minor process disturbances is reduced.

When a number of critical and important parameters or tags that affect a process grows large, the operator does not have the ability to keep track of all the parameters to prevent an alarm occurrence. In the related art, the operator may bring up the trends of a select few, very important parameters—that have may occur often and/or an impact of which is high—on a screen in the multi monitor environment. However, this may create tunnel vision for the operator, and the operator may miss changes in parameters—that occur rarely but their impact is still significant because they can affect the process.

Additionally, due to the interconnected nature of chemical processes, if a parameter in a process is allowed to drift, a single alarm might trigger a flood of alarms causing the operator to lose track of the root cause of the process upset. In the related art, the use of pre-upset warnings is unwieldy as they must be configured manually, and that is difficult to do on a large scale if there are hundreds or thousands of tags in a system.

Even in a single process unit, different process conditions may require different operation ranges, and manually configuring the parameters of the pre-upset warnings to these different operation ranges may be difficult. For example, different operations might mean that a refinery changes the grade of crude that is being blended or the production of a different output based on market demand.

Also, different operators, even in the same plant or process, may operate differently based on their experiences and on the production goal, e.g. maximize efficiency, maximize production, increase quality, etc.

Exemplary embodiments of the present application provide a method for automatically setting up parameters for the pre-upset warning conditions for entire systems based on drifting parameters. The parameters of the pre-upset warning conditions may be numerical set values for specific processes to indicate the operating state of the process. The exemplary embodiment may provide monitoring to operate the process so that the upset condition is never reached, so that the operator can take actions so that the process remains in a stable state. Exemplary embodiments aim to monitor and limit variations in parameters to enable the operator to achieve a much tighter control on the process and not allow the alarm to occur in the first place.

Additionally, exemplary embodiments may provide the important values in context via a display, as well as allow the operator to directly manipulate the values through a variety of touch input.

Drift Monitoring

Exemplary embodiments of the present application provide for a user interface where the operator is shown a summary of drift conditions. The summary can display and provide situational awareness of what parameters are drifting out of stable states for the operator to take action on.

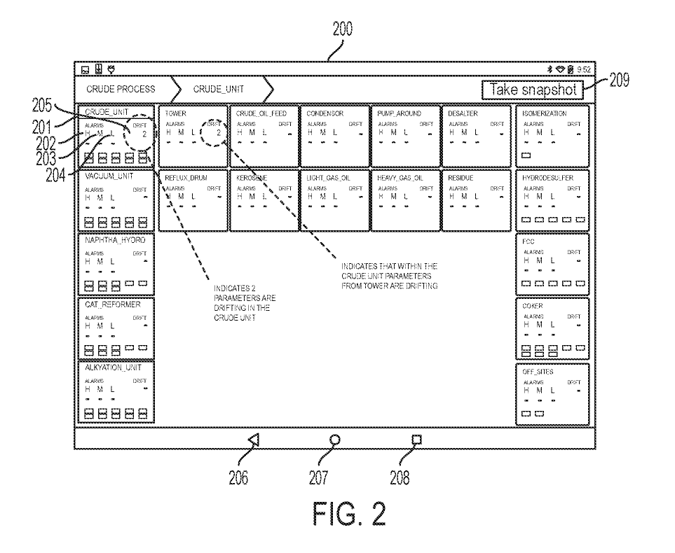

FIG. 2 shows an exemplary embodiment of the user interface (UI) (200) showing a summary of parameters and their drifting out of stable states. The operator can view the graphical display icons representing level 2 information (201). The level 2 icon (201) can then display summaries of alarm conditions and drift conditions for all of the lower level field devices and processes that fall under the level 2 process. For example, numerical displays can be provided for the number of instances of high priority alarms (H) (202), medium priority alarms (M) (203), and low priority alarms (L) (204), as well as the number of drifts (205). Additionally, the UI (200) may provide for a snapshot feature (209) as well as icons associated with native user interface icons (206, 207, 208) of a mobile device, e.g. [ANDROID]®.

In this way, the UI can clearly distinguish drift from alarms for the operator. The operator is also provided with an easy to review summary screen of whether there are drifts occurring. The UI also further provides a lay out to review lower level processes associated with the higher level, level 2 information.

In some embodiments, level 2 icons can be arranged along the vertical edges of the UI on both the left side edge and the right side edge. Alternatively, some embodiments may provide for the level 2 icons to be arranged along a left side edge of the UI. Clicking on a level 2 icon will display associated lower level processes in the center of the UI, e.g. Tower as a level 3 process of the level 2 Crude Unit process.

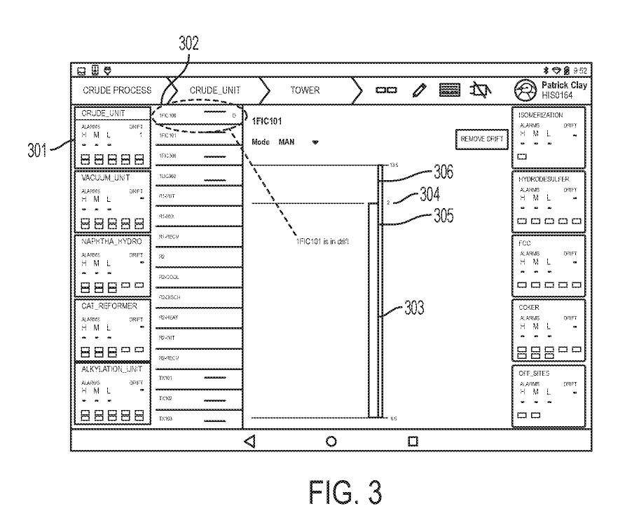

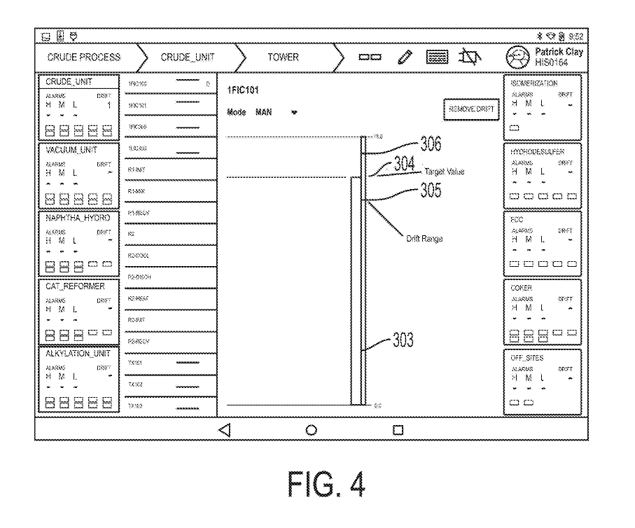

FIGS. 3 and 4 show embodiments of a UI following when the operator has further selected a level 3 process from the UI (200) of FIG. 2. In some embodiments, the level 2 process (301) is still displayed on at least one side edge, or both side edges, of the UI. The UI further includes a listing of specific field devices (302) associated with the level 3 process and a graphical display (303) of the operating state or value of the field device. The specific field device in the listing (302) that is experiencing drift may be indicated with an icon or annotation, such as a graphical letter “D.”

When the operator selects a specific device for the graphical display (303), the parameters for the range of the tolerable drift (305, 306) as well as a target value (304) may be shown. This provides additional context for the graphical display (303) as the settings.

In some embodiments, when an alarm overload occurs, the drift monitoring system can be turned off automatically to allow the operator to bring the alarm occurring process back to a stable condition. This would be useful since always alarms take higher priority than drift. Additionally, it is likely that there would be numerous drifts occurring in an alarm condition.

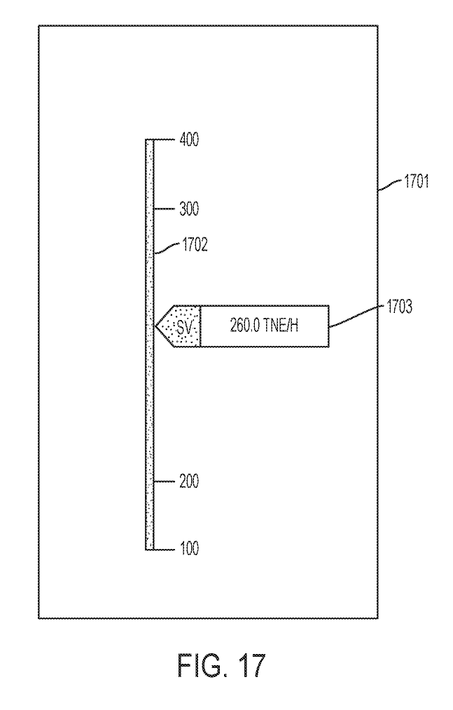

According to some embodiments, based on the process dynamics, the operator is able to define the tightness of control for each parameter. These values could be the output of a Real Time Optimizer (RTO) and shall be allowed to be imported into the system via a configuration file. Further to FIGS. 3 and 4, the operator can open up a tag/parameter, check its current state, and set the desired value of the parameter as well as adjust the range when the operator wants to be notified if the parameter drifts. Exemplary embodiments of adjusting the desired values and ranges can be found in FIGS. 17-21 as described below. The setting of a particular value or range may be brought up by further selecting the graphical display (303).

In some embodiments, if a configuration file is used, the default range for drift settings shall be the one that is imported. Alternatively, if there is no configuration file for importing, the drift range may be preset to a percentile range as desired, such as a default of 10% of the operating range.

In exemplary embodiments, where drift occurs to a sufficiently high degree, the system may automatically display the drifting parameters and bring up a user interface for the operator to make adjustments to parameters to bring the process within normal operating standards.

In some embodiments, the system may automatically adjust the field devices based on predetermined algorithms to bring operating states within norms. These algorithms may be predetermined or set by the operator based on experience. In these embodiments, the system may actively adjust the field device. Adjustment may be achieved through the use of a controller, such as a proportional-integral-derivative (PID) controller. A PID controller is a control loop feedback mechanism that is configured to attempt to minimize error between a measured PV and a desired SV. The PID controller may operate on the basis of an algorithm with three correcting terms, including a proportional term, an integral term, and a derivative term. The proportional term is proportional to a deviation value. The integral term considers the duration of deviation. The derivative term considers predicted system behavior in view of adjustments. One or combinations of these terms may be used for determining an adjustment amount to adjust the process. The PID controller can adjust the position of a component, such as a control valve or power supply, to attempt to correct any deviations. In some embodiments, the system may automatically begin to adjust the field devices when drift is experienced. This may allow for correction instead of further deviation into an alarm stage, even if an operator is unable to manually adjust the process.

In some embodiments, the adjustments are made to the tuning parameters (P, I & D constants) of a PID controller instead of the SV in the controller.

In some embodiments, algorithms such as a real time optimizer are placed on top of the drift detection and the algorithm adjusts the field values.

In exemplary embodiments, a series of possible actions could be tagged to the drift parameters. For example, particular drift notifications may cause automatic adjustments to be made according to established standard operating procedures. This may include adjustments in the process or setting a notification to check the process. Additionally, some embodiments may provide onscreen guides for the operator to review and analyze the drift notifications. Such an onscreen guides may be provided by software, such as [YOKOGAWA EXA-PILOT]®.

In exemplary embodiments, simulation may be used to predict the trend of the drift itself or the nature of how the process may move based on possible actions in the standard operating procedures.

In exemplary embodiments, when the simulation detects future process values to be unstable after taking into consideration a series of possible actions on a particular drift, an alarm or notification is raised to the operator.

Snapshot Configuration

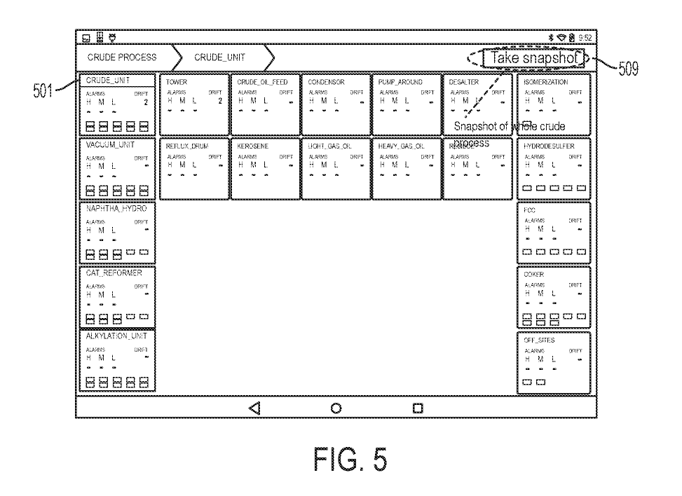

Exemplary embodiments provide for a snapshot feature (509) as shown in FIG. 5. The snapshot feature can be used to save data on the current operating conditions for the process. Primarily, it is intended for the saving of optimized configurations and drift settings for the process. In this way, the data can be saved and potentially exported for similar processes in other location or for back up in case there is a need for restoration of the system.

For example, if a plant is changing the process, e.g. switching between processing Saudi Arabia light crude and a different crude, the corresponding snapshot file can be restored quickly.

The snapshot feature can be configured to save all the data associated with the desired process, including lower level processes down to specific parameters of specific field devices.

In other embodiments, the snapshot feature may be used for troubleshooting. When non-optimal conditions can be saved through snapshot, they may be sent for analysis and discussion with other operators or researchers. This may provide aid to the operator in determining a corrective course of action.

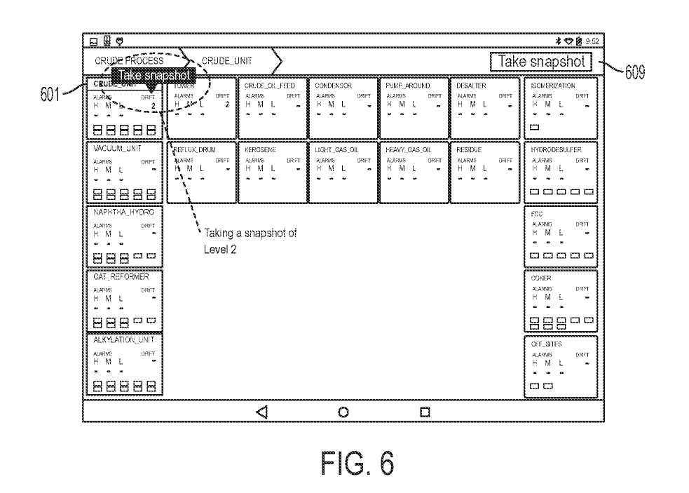

FIG. 6 shows an exemplary embodiment where a level 2 process (601) has been selected. When the system or operation is in a desired stable state, the operator notifies his intention to take a snapshot of the system by clicking the snapshot icon (609). The system then records all the current parameter values and stores them as the target values.

In some embodiments, the range for drift notification is also saved in the snapshot. Alternatively, the range for drift notification shall continue to come from a separate configuration.

By taking a snapshot of a level 2 process, all the lower level data from the specific field devices in the process is also saved.

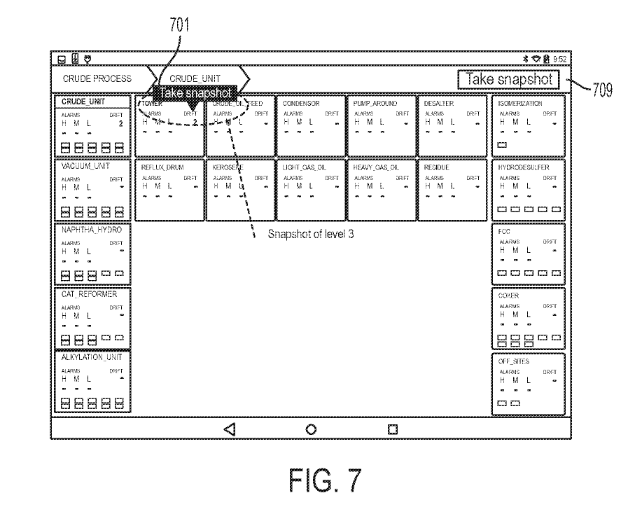

FIG. 7 shows an exemplary embodiment where a level 3 process (701) has been selected. When the system or operation is in a desired stable state, the operator notifies his intention to take a snapshot of the system by clicking the snapshot icon (709). The system then records all the current parameter values and stores them as the target values.

By allowing selective level based snapshot saving, the type and amount of saved data can be tailored to the specific needs of the operator. The snapshot saving would allow for the saving of the parameter values of the selected process as well as the saving of all related parameter values for the associated lower level processes. In such a way, the desired parameter value of the process can be recorded, wherein the process is selectable from a hierarchy of levels of processes. By doing so, the recording is configured to record the desired parameter value of the process and desired parameter values of associated lower level processes. Accordingly, if a higher level process is selected, all data for the associated lower level processes can also be recorded.

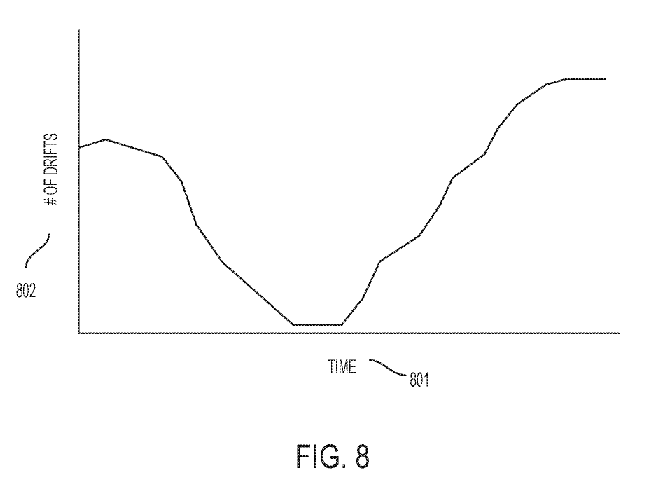

FIG. 8 shows an exemplary output that can be found from the snapshot. By analyzing the snapshot, the number of drifts at a given operating state can be checked in order to assess the overall efficiency of the process. Additionally, the number of drifts can be used as an evaluation of the operator's efficiency in addressing potential operating issues. One such output may be a graph (801) such as FIG. 8 to show the number of drifts over time. Evaluations may be made as to the efficiency of the operation and whether specific operators during particular shifts face specific challenges with drift.

In some embodiments, the snapshots can be automatically generated with software for real-time optimization (RTO) or advanced process control (APC). However, the snapshots could also be used in stand alone systems with manual operations.

Additionally, in some embodiments, the snapshots may be automatically loaded when a manufacturing execution system (MES) for the IA process detects changes in the process operating conditions. For example, if different inputs, such as a different crude oils, are detected, the MES system may automatically load the corresponding snapshot.

Implementation with a Mobile Device

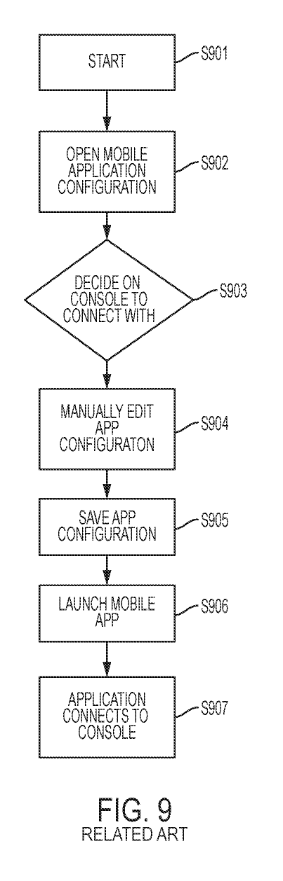

FIG. 9 shows a related art method of validating a mobile device for use with a console in a control room. To start (S901), the operator can open a mobile configuration (S902). With this, the operator must know which specific console the mobile device will connect with (S903). Once the operator knows the console, the mobile device application must be manually configured to connect to that console (S904). The necessary configuration information can include data such as the terminals name, IP address, port number, subnet, domain, user name and password. After this, the configuration information can be saved (S905) and the mobile application can be launched (S906) so that the connection process for the specified console can begin (S907).

This application configuration procedure must be repeated to connect to each individual console. Due to this manual configuration process, the mobile device cannot be quickly connected to multiple different consoles in the control room. Additionally, the process does not take proximity of the mobile device to the control room console into account.

In other related art embodiments, the related art may use NFC and proximity as part of the login process. However, this requires a two-step authentication and validation process, including exchanging security certificates between the proximity technology and the mobile device, prior to connection of the mobile device and the console.

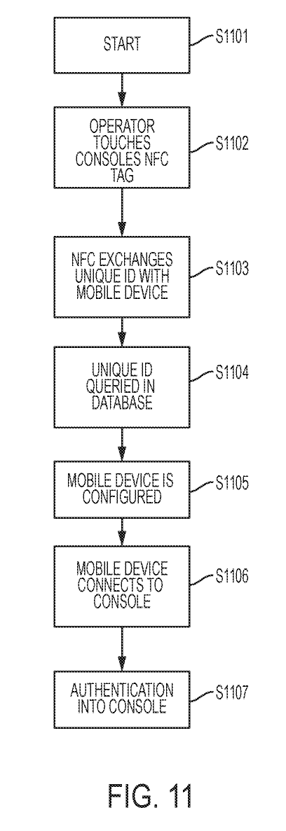

FIG. 11 shows an exemplary embodiment of a process using proximity to automatically configure and connect a mobile device to a console in an IA control room. Exemplary embodiments will use near field communication, such as NFC, to automatically configure and connect a mobile device to a control room console. By using NFC this will also require that the mobile device be in close proximity to the control room console that it is being connected to.

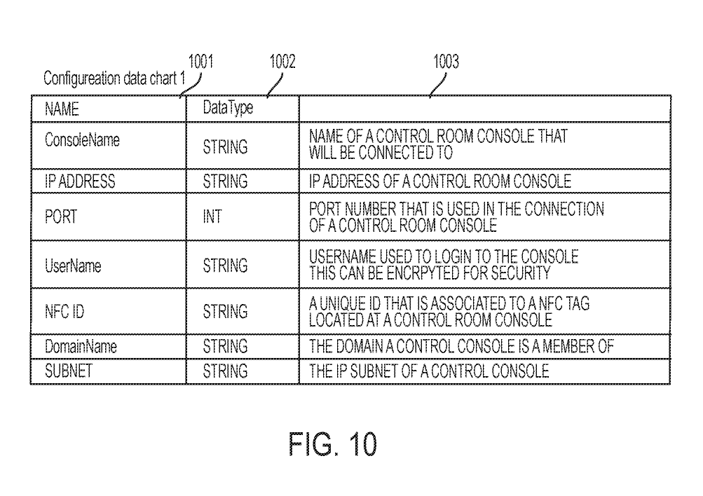

In exemplary embodiments, an NFC tag will be placed next to a control room console. Each NFC tag will contain a Unique ID that will identify the console that it is placed next to. This unique ID will be entered into a database, such as FIG. 10, and will contain the necessary information to configure and connect a mobile device or mobile application to a control room console. Configuration information can be added or subtracted to the configuration table as needed, depending on the control room network environment. Also, each NFC tag will be written with a unique ID for the console it represents in the control room.

To start the connection process a user will get a mobile device that has been approved and loaded for control room use (S1101). An operator will then bring the mobile device to the console they wish to be connected with. The mobile device will then touch the NFC tag at the console to begin the configuration and connection process (S1102). This will also satisfy the requirement that the mobile device starts the configuration process in close proximity to a control room console.

Once the mobile device has touched the NFC tag, an application on the mobile device will receive the NFC tag's unique identifier (S1103). The Mobile application will then look up the NFC tags unique identifier in the database (S1104). FIG. 10 shows an exemplary embodiment of a configuration database having information attributable to a feature name (1001), datatype (1002), and comments (1003). The information returned from the database will include the control room console's configuration information.

Using the returned configuration information in the database, the application will then be automatically configured to connect to the control room console (S1105). Following configuration, the application can connect itself to the control room console (S1106). Accordingly, the operator can then follow any additional authentication procedure required for that specific control room console (S1107).

Through the exemplary embodiments, the mobile device can be quickly connected to another control room console without needing manual configuration for each and every console.

As an alternative, some embodiments may use an RFID chip instead of NFC. The process would be the similar to use of NFC on the mobile device except that RFID would be used. The RFID chip would give the mobile device a unique ID. This RFID unique ID would then be used similarly to the NFC unique ID to look up the control room console's configuration information. The use of RFID would also necessitate that the mobile device be in close proximity to the control console it is connecting to.

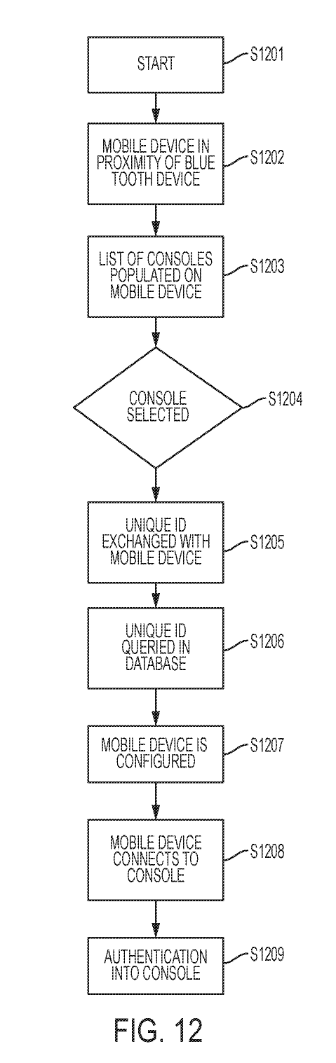

FIG. 12 shows an exemplary embodiment of a process using [BLUETOOTH]®. The use of low power [BLUETOOTH]® could ensure proximity and automatic configuration of a control room console. [IBEACON]® technology is an example of a low power [BLUETOOTH]® device. This embodiment would be similar to usage of NFC. However, instead of using a NFC tag to determine proximity to a console, a low power Bluetooth device would be used. Low power [BLUETOOTH]® can have a greater detection range than NFC or RFID.

Separately from NFC and RFID, it may be necessary to populate a list of control room consoles detected in close proximity using [BLUETOOTH]®. In some embodiments, the operator would have to select which console the mobile device is to be configured and connected with. A feature of low power [BLUETOOTH]® devices is that the signal strength can be adjusted. This will affect the proximity range that a mobile device must be in order to detect a low power [BLUETOOTH]® device. As such, the usage of [BLUETOOTH]® may be adjusted to suit particular control room layouts and console spacing to improve efficiency for connections.

To start the connection process, the operator will get a mobile device that has been approved and loaded for control room use (S1201). The operator will bring the mobile device in the proximity of the console they wish to be connected with (S1202). A mobile application on the mobile device will then be able to detect the nearby low power [BLUETOOTH®] devices affiliated with the consoles.

A list of control room consoles will be populated on the mobile device (S1203) and the operator can select a console that will be automatically configured and connected with (S1204).

The low power [BLUETOOTH]® device will then provide the mobile application with a unique ID (S1205). The Mobile application will then look up the unique ID from the low power [BLUETOOTH]® device in the database (S1206). The information returned from the database will be the control room consoles configuration information.

Using the returned configuration information in the database, the application can be automatically configured to connect to the control room console (S1207). The application will now connect itself to the control room console (S1208). Accordingly, the operator can then follow any additional authentication procedure required for that specific control room console (S1209).

Through the exemplary embodiments, the mobile device can be quickly connected to another control room console without needing manual configuration for each and every console.

In some embodiments, the use of the mobile device may be linked with specific user rights or user profiles. These may enable the ability to selectively configure access and monitoring of particular processes. In this way, the operator on the mobile device may be able to selectively monitor processes of interest without having to respond or be alerted to changes in separate processes. In some complex processes, there may be multiple operators, each operator being responsible for one section or portion of the process. In such a case, the operator does not need to monitor all elements of the processes. By selectively linking particular processes with the mobile device, the operator is not encumbered by excessive, irrelevant information. For example, an operator might choose to only link to TOWER or CRUDE_OIL_FEED as shown in FIG. 2 and thereby not be interrupted if the separate DESALTER process drifts.

Some embodiments may allow for the operator to view all of the processes while only allowing modification of particular linked processes. Other embodiments may only allow viewing and modification of the particular processes.

In these embodiments, specific mobile devices, user rights, or user profiles may be limited to modification of specific processes in order to prevent accidental changes to other processes. By preventing modification of parameters outside of the particular processes, the operator cannot accidently modify the settings of a process that is not assigned to the operator. This prevents potential error where another operator responsible that particular process may not be aware of changes in the pre-upset warning conditions until an alarm has occurred.

Additionally, in cases where a supervisor or visitor may be using a mobile device to monitor the processes, the accidental modification of unrelated processes may be prevented.

Touch Interaction

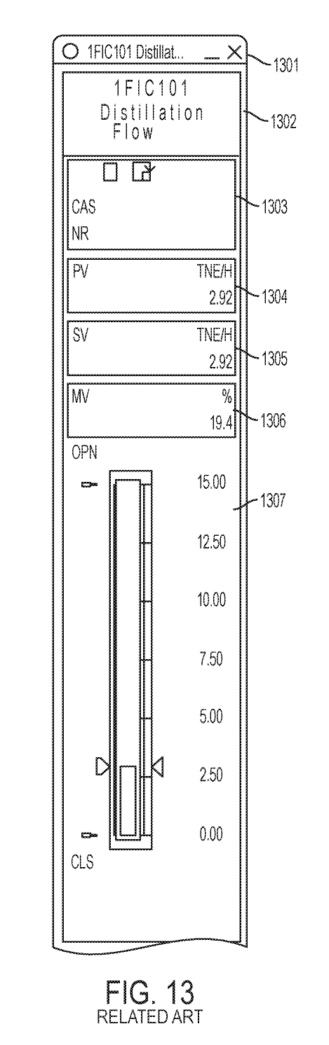

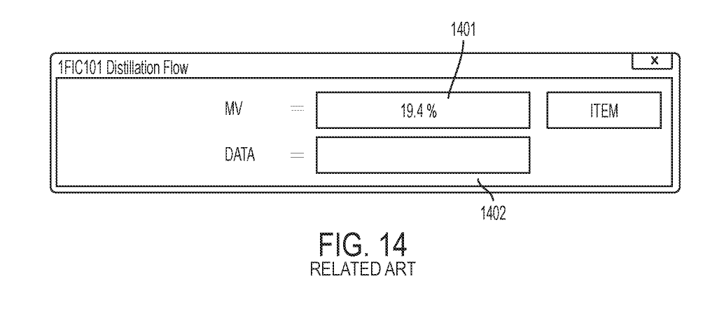

FIG. 17 shows an exemplary embodiment for a user interface (1701) configured for touch adjustment of a setting parameter. In contrast to the related art menu of FIG. 14 with a text entry method, the user interface provides for a graph (1702) and a slider indicator (1703). The related art faceplate display of FIG. 13 does not provide much context for what the values represent or what their upper and lower bounds are. Furthermore, the interaction takes places solely with keyboard and mouse, which is disadvantageous to a touch screen device.

In contrast, the slider indicator (1703) indicates a configurable value within a range of the graph (1702). The slider indicator (1703) is movable corresponding to the movement of the operator's touch inputs. Touch movement up or down moves the slide indicator (1703) up or down within a range. The distance that the slide indicator (1703) moves is correlated to how many fingers are being used.

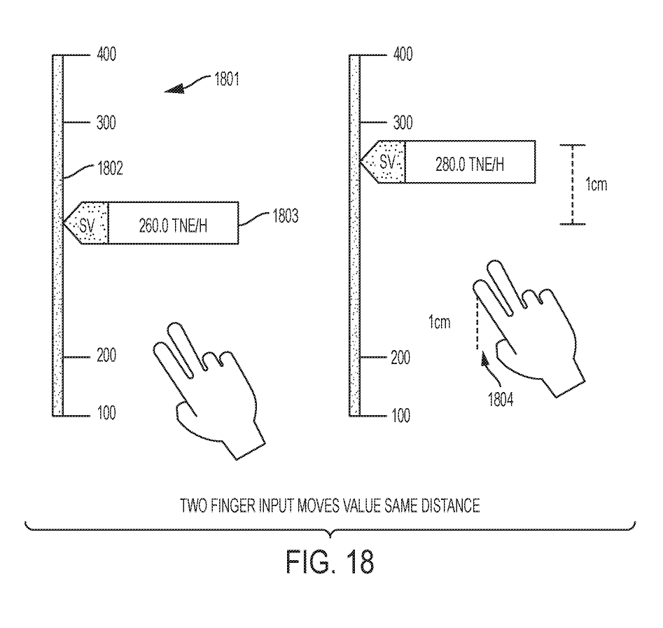

FIG. 18 shows an exemplary embodiment wherein a two finger input by the operator results in an equal amount of corresponding movement of the slider indicator (1803) along the graph (1802) of a user interface (1801). For example, if the operator slides two fingers 1 centimeter on the touch interface, the slider indicator (1803) would also move 1 centimeter.

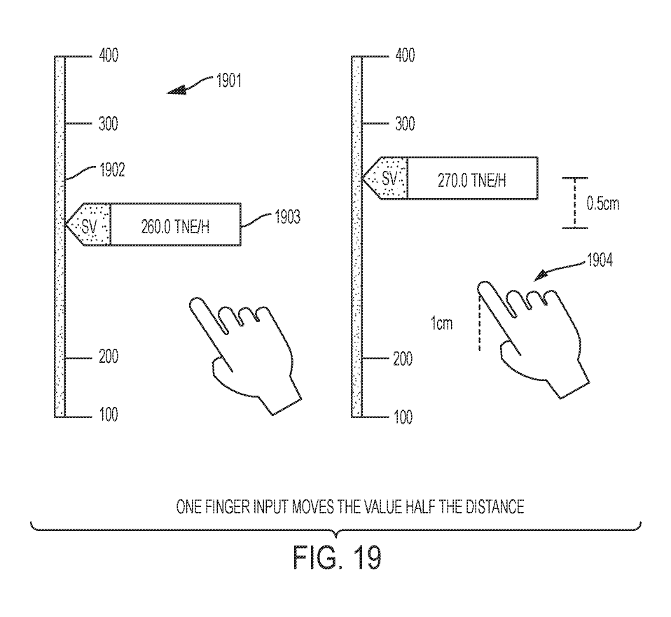

FIG. 19 shows an exemplary embodiment wherein a one finger input by the operator results in an smaller amount of corresponding movement of the slider indicator (1903) along the graph (1902) of a user interface (1901). For example, if the operator slides one fingers 1 centimeter on the touch interface, the slider indicator (1903) would move 0.5 centimeter.

Alternative embodiments may switch the responses between one finger and two finger operation, such that the two finger operation results in the smaller corresponding movement.

Additionally, the function in which the distance degrades with fewer inputs could be something other than a reduction by half. The corresponding movement of the slider indicator based on the touch input may be set at other proportional ratios. The distance the value moves is directly proportional to the distance the input touches travels on the display, and, in some embodiments, one of the touch input methods may result in movement that is twice the touch input.

By having different movement responses, the operator can be provided with the ability to make coarse and fine adjustments of the slider indicator. This is in contrast to a single correspondence method, where one may find that the control of the movement of the slider indicator is difficult for fine adjustments due to large movements of the slider indicator based on the touch input or for coarse adjustments due to small movements of the slider indicator based on the touch input.

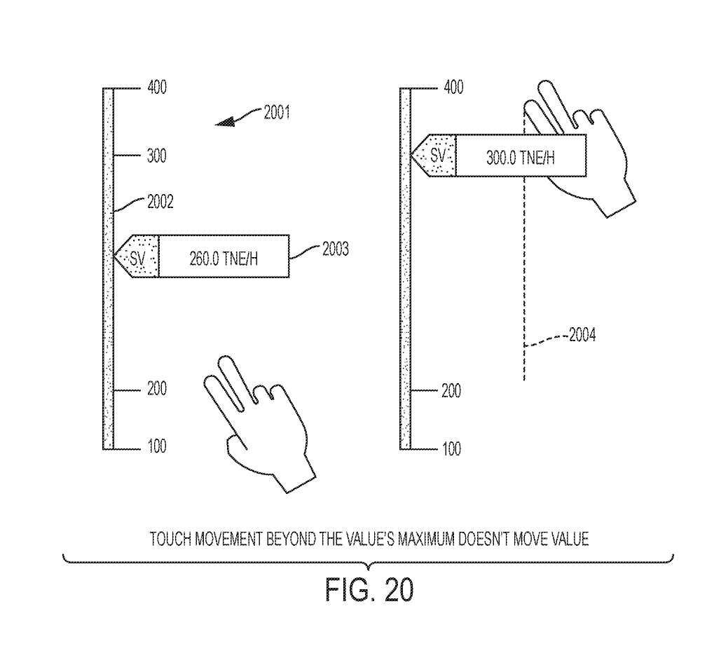

FIG. 20 shows an embodiment where the potential adjustment value of the slider indicator (2003) along the graph (2002) of a user interface (2001) is set within a predetermined range. Accordingly, even if movement (2004) of the operator is large, the slider indicator (2003) will stop movement upon hitting the boundary of the predetermined range.

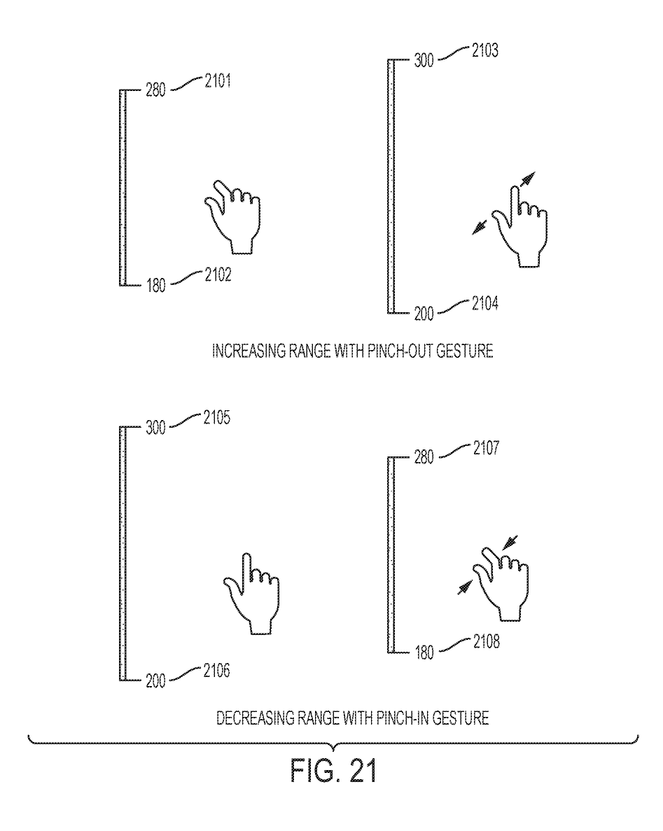

FIG. 21 shows an embodiment where the display range of the graph (2102) of a user interface (2101) can be adjusted through pinch-in and pinch-out gestures. When a range needs to be configured, a pinch-in gesture will reduce the range and a pinch-out gesture will extend the range. Alternatively, the reverse correspondence may be configured.

In some embodiments, a user interface may utilize additional input touches to further adjust the proportional movement of the slider indicator in response to touch inputs by the operator. This relationship could be extrapolated out to any number of input touches, where each additional touch changes the proportional movement of the slider indicator.

For example, in an exemplary embodiment where the maximum number of touches moves the slider indicator the same distance as the distance of the touches, one fewer touch results in travel of half the distance, two fewer touches results in travel of a quarter of the distance, and so on. Alternatively, the opposite may be true that one touch results in the slide indicator moving the same distance as the distance of the touch and additional touches reduces the distance that the slide indicator moves. The maximum number of touches necessary can be determined by the granularity, or level of detail, as required.

In application, the touch input system may be used to adjust the individual limitations of the drift range configuration.

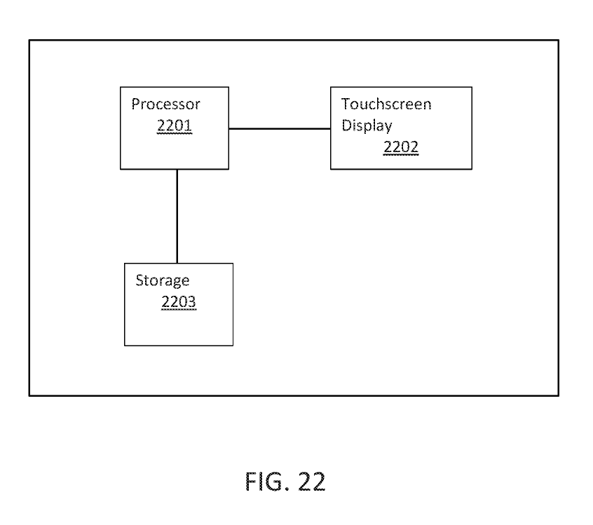

FIG. 22 shows an exemplary device that may achieve the method having a processor (2201), a touchscreen display (2202), and a storage medium (2203).

Although this specification has been described above with respect to the exemplary embodiments, it shall be appreciated that there can be a variety of permutations and modifications of the described exemplary features by those who are ordinarily skilled in the art without departing from the technical ideas and scope of the features, which shall be defined by the appended claims.

A method of one or more exemplary embodiments may be recorded as computer-readable program codes in non-transitory computer-readable media (CD ROM, random access memory (RAM), read-only memory (ROM), floppy disks, hard disks, magneto-optical disks, and the like) including program instructions to implement various operations embodied by a computer.

While this specification contains many features, the features should not be construed as limitations on the scope of the disclosure or of the appended claims. Certain features described in the context of separate embodiments can also be implemented in combination. Conversely, various features described in the context of a single exemplary embodiment can also be implemented in multiple exemplary embodiments separately or in any suitable sub-combination.

Although the drawings describe the user interface (UI) views in a specific order or layout, one should not interpret that the UI views are performed in a specific order or layout as shown in the drawings or successively performed in a continuous order, or that all the UI views are necessary to obtain a desired result. Also, it should be noted that all embodiments do not require the distinction of various system components made in this description. The device components and systems may be generally implemented as a single software product or multiple software product packages.

A number of examples has been described above. Nevertheless, it is noted that various modifications may be made. For example, suitable results may be achieved if the described techniques are performed in a different order and/or if components in a described system, architecture, or device are combined in a different manner and/or replaced or supplemented by other components or their equivalents. Accordingly, other implementations are within the scope of the following claims.

There is claimed:

1. A method for setting drift warnings for monitoring processes that are applicable to a plant operating according to a process control and having a plurality of field devices, the method comprising:
configuring a desired range for an acceptable drift range of a plant process;
setting a desired parameter value for the operating of the plant process;
detecting an actual parameter value of the plant process;
comparing the actual parameter value to the desired parameter value and the desired range; and
displaying an indication of a drift occurrence when the actual parameter value is within the desired range but different from the desired parameter value.

2. The method according to claim 1, further comprising:
automatically adjusting a field device parameter to maintain the actual parameter value at the desired parameter value.

3. The method according to claim 1, wherein at least one of an adjustment of the desired parameter value and drift range is by a touch input of an operator.

4. The method according to claim 3,
wherein the adjustment occurs through at least two touch inputs,
wherein a first touch input is configured to make the adjustment at a first rate corresponding to the movement of the touch input of the operator, and
wherein a second touch input is configured to make the adjustment at a second rate, proportionally different from the first rate, corresponding to the movement of the touch input of the operator.

5. The method according to claim 1, further comprising recording a current desired parameter value of the process.

6. The method according to claim 1, further comprising saving the desired parameter value and the desired range into a configuration file.

7. The method according to claim 1, further comprising:
recording a desired parameter value of the plant process,
wherein the plant process is selectable from a hierarchy of levels of plant processes such that the recording is configured to record the desired parameter value of the plant process and desired parameter values of associated lower level plant processes.

8. A system comprising at least one device for setting drift warnings for monitoring processes in a plant operating according to a process control and having a plurality of field devices, the system comprising:
at least one non-transitory computer readable medium operable to store program code;
at least one processor operable to read said program code and operate as instructed by the program code, the program code comprising:
configuring a desired range for an acceptable drift range of a plant process;
setting a desired parameter value for the operating of the plant process;
detecting an actual parameter value of the plant process;
comparing the actual parameter value to the desired parameter value and the desired range; and
displaying an indication of a drift occurrence when the actual parameter value is within the desired range but different from the desired parameter value.

9. The system according to claim 8, the program code further comprising:
automatically adjusting a field device parameter to maintain the actual parameter value at the desired parameter value.

10. The system according to claim 8, wherein at least one of an adjustment of the desired parameter value and drift range is by a touch input of an operator.

11. The system according to claim 10,
wherein the adjustment occurs through at least two touch inputs,
wherein a first touch input is configured to make the adjustment at a first rate corresponding to the movement of the touch input of the operator, and
wherein a second touch input is configured to make the adjustment at a second rate, proportionally different from the first rate, corresponding to the movement of the touch input of the operator.

12. The system according to claim 8, the program code further comprising recording a current desired parameter value of the process.

13. The system according to claim 8, the program code further comprising saving the desired parameter value and the desired range into a configuration file.

14. The system according to claim 8, the program code further comprising:
receiving a device identifier associated with a process management console;
retrieving configuration data for connection to the process management console; and
automatically configuring the system to connect to the process management console based on the configuration data,
wherein the process management console provides information regarding the process to the system.

15. An apparatus for setting drift warnings for monitoring processes in a plant operating according to a process control and having a plurality of field devices, the apparatus comprising:
at least one non-transitory computer readable medium operable to store program code;
at least one processor operable to read said program code and operate as instructed by the program code, the program code comprising:
configuring a desired range for an acceptable drift range of a plant process;
setting a desired parameter value for the operating of the plant process;
detecting an actual parameter value of the plant process;
comparing the actual parameter value to the desired parameter value and the desired range; and
displaying an indication of a drift occurrence when the actual parameter value is within the desired range but different from the desired parameter value.

16. The apparatus according to claim 15, the program code further comprising:
automatically adjusting a field device parameter to maintain the actual parameter value at the desired parameter value.

17. The apparatus according to claim 15, wherein at least one of an adjustment of the desired parameter value and drift range is by a touch input of an operator.

18. The apparatus according to claim 17,
wherein the adjustment occurs through at least two touch inputs,
wherein a first touch input is configured to make the adjustment at a first rate corresponding to the movement of the touch input of the operator, and
wherein a second touch input is configured to make the adjustment at a second rate, proportionally different from the first rate, corresponding to the movement of the touch input of the operator.

19. The apparatus according to claim 15, the program code further comprising recording a current desired parameter value of the process.

20. The apparatus according to claim 15, the program code further comprising saving the desired parameter value and the desired range into a configuration file.

21. The apparatus according to claim 15, the program code further comprising:
receiving a device identifier associated with a process management console;
retrieving configuration data for connection to the process management console; and
automatically configuring the system to connect to the process management console based on the configuration data,
wherein the process management console provides information regarding the process to the system.
